(19) United States
(12) Patent Application Publication
(10) Pub. No.: US 2025/0289056 A1
(43) Pub. Date: Sep. 18, 2025

(54) ADDITIVE MANUFACTURING SYSTEMS AND METHODS

(71) Applicant: Precision Additive Solutions Inc., Indianapolis, IN (US)

(72) Inventor: Bala Anand JELDI, Carmel, IN (US)

(73) Assignee: Precision Additive Solutions Inc., Indianapolis, IN (US)

(21) Appl. No.: 19/085,278

(22) Filed: Mar. 20, 2025

Related U.S. Application Data
(63) Continuation of application No. PCT/US2025/020081, filed on Mar. 14, 2025.
(60) Provisional application No. 63/566,058, filed on Mar. 15, 2024.

(51) Int. Cl. B22F 10/368; B22F 10/28; B22F 12/45; B23K 26/06; B23K 26/073; B23K 26/342; B23K 26/70; B23K 103/14; B33Y 10/00; B33Y 30/00; B33Y 50/02

(52) U.S. Cl. CPC B22F 10/368; B22F 10/28; B22F 12/45; B23K 26/0608; B23K 26/0626; B23K 26/073; B23K 26/342; B23K 26/705; B33Y 10/00; B33Y 30/00; B33Y 50/02; B23K 2103/14

(57) ABSTRACT

An additive manufacturing method may provide energy beams to gradually heat the working material, to fuse the working material, and to gradually cool the working material in a controlled method. The energy beams may be provided by a plurality of laser assemblies. The energy beams may produce an irradiation profile including a first portion that heats the working material to a first peak temperature lower than a melting point of the working material, a second portion that heats the working material to a second peak temperature being higher than the first peak temperature and lower than the melting point of the working material, a third portion that heats the working material to a third peak temperature being higher than the melting point of the working material and lower than a boiling point of the working material, and a fourth portion that heats the working material to a fourth peak temperature being less than the third peak temperature. The irradiation profile may be moved along the working path such that a portion of the working material along the working path sequentially encounters the first portion, the second portion, the third portion, and the fourth portion.

### RELATED APPLICATION

This application is a continuation of PCT Application No. PCT/US25/20081, filed Mar. 14, 2025, titled ADDITIVE MANUFACTURING SYSTEMS AND METHODS which claims the benefit of U.S. Provisional Application No. 63/566,058, filed Mar. 15, 2024, titled ADDITIVE MANUFACTURING APPARATUS AND METHOD, the entire disclosures of which are expressly incorporated by reference herein.

### FIELD OF THE DISCLOSURE

The present disclosure relates to additive manufacturing and more specifically to improved methods and apparatuses utilizing laser fusion and/or sintering.

### BACKGROUND OF THE DISCLOSURE

Additive manufacturing utilizes a combination of components to build or print parts in a three-dimensional space. Unlike more conventional manufacturing methods such as milling, casting, molding, pressing, etc., additive manufacturing can be used to manufacture the same components with complex geometries and sophisticated interface comparatively faster and with less work required than more conventional methods.

One form of additive manufacturing is Selective Laser Sintering (“SLS”). SLS uses a laser to heat and sinter a source material that is often in powdered form. The laser is specifically directed to a location in three-dimensional (“3D”) space to fuse particles at the desired location to build a 3D part, often based on a 3D model generated via a Computer Aided Design (“CAD”) system. Other similar forms of additive manufacturing include Selective Laser Melting (“SLM”) which generally applies similar principles as SLS to create a 3D part utilizing a laser to selectively melt a working material.

Conventional SLS and SLM systems utilize a single laser to quickly heat the working material to above the melting point to allow adjacent particulate of the working material to fuse together and create the 3D part. However, the single laser often heats the working material to temperatures far exceeding the melting point and a boiling point (vaporization point) and causes vaporization phenomenon including spatter. Further, a single laser configuration lets the material cool without any controlled cooling leading to residual stress. Among other things, this overheating of the working material can cause material characteristic changes in the working material as the working material undergoes extreme temperature changes in a short amount of time. These fundamental material characteristic changes can cause the created part to have unpredictable material properties and unhomogenous properties due to the imprecise heating applied and uncontrolled cooling to the working material during conventional SLS or SLM processes.

More specifically, the extreme temperature gradients applied to the source material in conventional systems may cause cracks, micro porosity, dealloying and residual stress internally on the 3D part. These defects are formed because of stress induced by rapid powder melting related to the excessive temperature gradient and uncontrolled cooling rates cause material brittleness among other things. In view thereof, conventional systems often create inconsistent material characteristics and non-repeatable properties in 3D parts. Further, conventional systems often cause material vaporization during the melting process due to the excessive heat, which leads to metal loss, dealloying, and oxide precipitation among other things.

In view thereof, there is a need in the art for a system and method that allows for an additive manufacturing process that carefully controls the heating parameters and controls the cooling of the heated zone applied to the source material during the additive manufacturing process, among other things.

### SUMMARY

In an exemplary embodiment of the present disclosure, a method for additive manufacturing of an in situ model of a part from a working material having a plurality of powder particles is provided. The method may comprises providing a plurality of laser assemblies; selectively heating the working material with a first laser beam from a first laser assembly of the plurality of laser assemblies to a first peak temperature; selectively heating the working material with a second laser beam from a second laser assembly of the plurality of laser assemblies to a second peak temperature subsequent to the working material being heated to the first peak temperature with the first laser assembly of the plurality of laser assemblies; and selectively heating the working material to a third peak temperature with a third laser beam from a third laser assembly of the plurality of laser assemblies subsequent to the working material being heated to the second peak temperature with the second laser assembly of the plurality of laser assemblies. The first peak temperature being lower than a melting point of the working material. The second peak temperature being higher than the first peak temperature and the second peak temperature being lower than the melting point of the working material. The third peak temperature being higher than the melting point of the working material causing adjacent particles of the working material to fuse to one another.

In an example thereof, the method may further comprise the step of selectively heating the working material to a fourth peak temperature with a fourth laser beam from a fourth laser assembly of the plurality of laser assemblies subsequent to the working material being heated to the third temperature with the third laser assembly of the plurality of laser assemblies. The fourth peak temperature being less than the third peak temperature.

In another example thereof, the working material cools to a fifth temperature less than the fourth peak temperature prior to the step of selectively heating the working material to the fourth peak temperature.

In a further example thereof, the method may further comprise the step of cooling the working material between the step of selectively heating the working material with the first laser assembly and the step of selectively heating the working material with the second laser assembly.

In yet another example thereof, the method may further comprise the step of cooling the working material between the step of selectively heating the working material with the second laser assembly and the step of selectively heating the working material with the third laser assembly.

In yet a further example thereof, the method may further comprise the step of cooling the working material between the step of selectively heating the working material with the third laser assembly and the step of selectively heating the working material with the fourth laser assembly.

In still another example thereof, the first peak temperature is in the range of about 40% to about 80% of the melting point of the working material.

In still a further example thereof, the second peak temperature is in the range of about 70% to about 95% of the melting point of the working material.

In yet still another example thereof, the fourth peak temperature is in the range of about 50% to about 98% of the melting point of the working material.

In a further still example thereof, the first peak temperature is at least about 50% of the melting point of the working material.

In another still example thereof, the second peak temperature is at least about 90% the melting point of the working material.

In another example thereof, the fourth peak temperature is at least about 90% the melting point of the working material.

In a further example thereof, the method further comprises the step of moving an irradiation profile produced by the first laser assembly, the second laser assembly, the third laser assembly, and the fourth laser assembly relative to the working material along a working path. The first laser assembly producing a first portion of the irradiation pattern which heats the working material to the first peak temperature. The second laser assembly producing a second portion of the irradiation pattern which heats the working material to the second peak temperature. The third laser assembly producing a third portion of the irradiation pattern which heats the working material to the third peak temperature. The fourth laser assembly producing a fourth portion of the irradiation pattern which heats the working material to the fourth peak temperature.

In another still example thereof, as the irradiation profile is moved along the working path the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration.

In a further still example thereof, the third time duration is up to about 50% of the first time duration.

In yet another example thereof, the third time duration is up to about 50% of the second time duration.

In yet a further example thereof, the third time duration is up to about 25% of the fourth time duration.

In yet still another still example thereof, the third time duration is up to about 18% of the fourth time duration.

In yet still a further example thereof, the first time duration is up to about 50% of the fourth time duration.

In another example thereof, the first time duration is up to about 33% of the fourth time duration.

In a further example thereof, the second time duration is up to about 50% of the fourth time duration.

In still another example thereof, the second time duration is up to about 33% of the fourth time duration.

In still a further example thereof, the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

In another example thereof, the third power profile mode is a Gaussian mode.

In a further example thereof, the second power profile mode and the fourth power profile mode are each a flat top mode.

In still a further example thereof, the first power profile mode is a doughnut mode.

In another exemplary embodiment of the present disclosure, a method for additive manufacturing of an in situ model of a part from a working material having a plurality of powder particles is provided. The method comprising: providing a plurality of laser assemblies; controlling a first subset of the plurality of laser assemblies to heat a portion of the working material in a stepped increase in temperature target points; fusing the portion of the working material with a second subset of the plurality of laser assemblies; and modifying a post fusion temperature of the portion of the working material with a third subset of the plurality of laser assemblies to provide a controlled cooling temperature decline of the portion of the working material post fusion. The stepped increase in temperature target points including a plurality of steps. A first step of the plurality of steps being spaced apart from a second step of the plurality of steps by a beam gap portion. The portion of the working material cools during the beam gap portion. At least two laser assemblies of the plurality of laser assemblies are directed towards the portion of working material to provide heat to gradually raise a temperature of the portion of the working material above a melting point of the working material while keeping the temperature of the portion of the working material at about or below a boiling point of the working material.

In example thereof, the first subset of the plurality of laser assemblies includes a first laser assembly and a second laser assembly.

In another example thereof, the first subset and the second subset of the plurality of laser assemblies are disjoint.

In a further example thereof, the first subset and the third subset of the plurality of laser assemblies are disjoint.

In still another example thereof, the second subset and the third subset of the plurality of laser assemblies are disjoint.

In yet another exemplary embodiment of the present disclosure, a method for additive manufacturing of an in situ model of a part from a working material having a plurality of powder particles is provided. The method comprising the steps of: producing an irradiation profile with an illumination system; directing the irradiation profile towards the working material; and moving the irradiation profile along a working path at the working material to fuse adjacent particles of the working material along the working path together. The irradiation profile including (a) a first portion that heats the working material to a first peak temperature lower than a melting point of the working material, (b) a second portion that heats the working material to a second peak temperature being higher than the first peak temperature and lower than the melting point of the working material, (c) a third portion that heats the working material to a third peak temperature being higher than the melting point of the working material, and (d) a fourth portion that heats the working material to a fourth peak temperature being less than the third peak temperature. As the irradiation profile is moved along the working path a portion of the working material along the working path sequentially encounters the first portion, the second portion, the third portion, and the fourth portion.

In an example thereof, a first gap is provided between the first portion and the second portion, the working material heated by the first portion cools during the first gap.

In another example thereof, a second gap is provided between the second portion and the third portion, the working material heated by the second portion cools during the second gap.

In still another example thereof, a third gap is provided between the third portion and the fourth portion, the working material heated by the third portion cools during the third gap.

In yet another example thereof, the first peak temperature is in the range of about 40% to about 80% of the melting point of the working material.

In still yet another example thereof, the second peak temperature is in the range of about 70% to about 95% of the melting point of the working material.

In a further example thereof, the fourth peak temperature is in the range of about 50% to about 98% of the melting point of the working material.

In yet a further example thereof, the first peak temperature is at least about 50% of the melting point of the working material.

In yet still a further example thereof, the second peak temperature is at least about 90% the melting point of the working material.

In another example thereof, he fourth peak temperature is at least about 90% the melting point of the working material.

In yet another example thereof, as the irradiation profile is moved along the working path the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration.

In still another example thereof, the third time duration is up to about 50% of the first time duration.

In a further example thereof, the third time duration is up to about 50% of the second time duration.

In still a further example thereof, the third time duration is up to about 25% of the fourth time duration.

In yet a further example thereof, the third time duration is up to about 18% of the fourth time duration.

In another example thereof, the first time duration is up to about 50% of the fourth time duration.

In still another example thereof, the first time duration is up to about 33% of the fourth time duration.

In a further example thereof, the second time duration is up to about 50% of the fourth time duration.

In yet a further example thereof, the second time duration is up to about 33% of the fourth time duration.

In still a further example thereof, at least two of the first peak temperature, the second peak temperature, the third peak temperature, and the fourth peak temperature are independently adjustable.

In another example thereof, at least three of the first peak temperature, the second peak temperature, the third peak temperature, and the fourth peak temperature are independently adjustable.

In still another example thereof, each of the first peak temperature, the second peak temperature, the third peak temperature, and the fourth peak temperature are independently adjustable.

In yet another example thereof, at least two of the first time duration, the second time duration, the third time duration, and the fourth time duration are independently adjustable.

In a further example thereof, at least three of the first time duration, the second time duration, the third time duration, and the fourth time duration are independently adjustable.

In yet a further example thereof, each of the first time duration, the second time duration, the third time duration, and the fourth time duration are independently adjustable.

In still a further example thereof, the method further comprises the step of providing the irradiation profile with a plurality of laser assemblies.

In yet still a further example thereof, the first portion of the of the irradiation profile is provided with a first laser assembly of the plurality of laser assemblies, the second portion of the of the irradiation profile is provided with a second laser assembly of the plurality of laser assemblies, the third portion of the of the irradiation profile is provided with a third laser assembly of the plurality of laser assemblies, and the fourth portion of the of the irradiation profile is provided with a fourth laser assembly of the plurality of laser assemblies.

In another example thereof, the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

In yet another example thereof, the third power profile mode is a Gaussian mode.

In still another example thereof, the second power profile mode and the fourth power profile mode are each a flat top mode.

In yet still another example thereof, the first power profile mode is a doughnut mode.

In a further exemplary embodiment of the present disclosure, an additive manufacturing system for forming an in situ model of a part from a working material having a plurality of powder particles is provided. The additive manufacturing system comprising: a powder bed adapted to support the working material; an illumination system configured to illuminate the working material with an irradiation profile; and a controller configured to cause the illumination system to follow a working path while illuminating the working material with the irradiation profile. The irradiation profile including (a) a first portion that heats the working material to a first peak temperature lower than a melting point of the working material, (b) a second portion that heats the working material to a second peak temperature being higher than the first peak temperature and lower than the melting point of the working material, (c) a third portion that heats the working material to a third peak temperature being higher than the melting point of the working material, and (d) a fourth portion that heats the working material to a fourth peak temperature being less than the third peak temperature, wherein as the irradiation profile is moved along the working path a portion of the working material along the working path sequentially encounters the first portion, the second portion, the third portion, and the fourth portion.

In an example thereof, the controller is further configured to execute the methods disclosed herein.

In yet a further exemplary embodiment of the present disclosure, an additive manufacturing system for forming an in situ model of a part from a working material having a plurality of powder particles is provided. The additive manufacturing system comprising: a powder bed supporting the working material; an illumination system configured to illuminate the working material with an irradiation profile; and a controller configured to cause the illumination system to follow a working path while illuminating the working material with the irradiation profile. The irradiation profile including a plurality of spaced apart portions which each selectively heat the working material to a plurality of spaced apart peak temperatures. The plurality of spaced apart peak temperatures all being lower than a boiling point of the working material. The plurality of spaced apart portions including a first subset pre-heating a portion of the working material while keeping a temperature of the portion of the working material below a melting point of the portion of the working material, a second subset fusing the portion of the working material while keeping the temperature of the portion of the working material below the boiling point of the working material; and a third subset post-heating the portion of the working material while keeping the temperature of the portion of the working material below the melting point. The additive manufacturing system further comprising at least one camera oriented to observe the portion of the working material. The controller is configured to analyze image data provided by the camera while the illumination system follows the working path.

In an example thereof, the controller is further configured to adjust at least one of the plurality of spaced apart portion of the irradiation profile based on the image data while the illumination system follows the working path to improve a characteristic of the in situ model.

In another example thereof, the characteristic of the in situ model is a porosity of the in situ model.

In yet another example thereof, the controller is further configured to provide a quality assessment of the in situ model produced by the printing process based on the image data.

In still another example thereof, the spaced apart portions of the irradiation profile include (a) a first portion that heats the working material to a first peak temperature of the plurality of spaced apart peak temperatures lower than a melting point of the working material, (b) a second portion that heats the working material to a second peak temperature of the plurality of spaced apart peak temperatures being higher than the first peak temperature and lower than the melting point of the working material, (c) a third portion that heats the working material to a third peak temperature of the plurality of spaced apart peak temperatures being higher than the melting point of the working material and lower than the boiling point of the working material, and (d) a fourth portion that heats the working material to a fourth peak temperature of the plurality of spaced apart peak temperatures being less than the third peak temperature, wherein the first portion and the second portion are part of the first subset, the third portion is part of the second subset, and the fourth portion is part of the third subset, as the irradiation profile is moved along the working path the portion of the working material sequentially encounters the first portion, the second portion, the third portion, and the fourth portion.

In a further example thereof, a first gap is provided between the first portion and the second portion, the working material heated by the first portion cools during the first gap; a second gap is provided between the second portion and the third portion, the working material heated by the second portion cools during the second gap; and a third gap is provided between the third portion and the fourth portion, the working material heated by the third portion cools during the third gap.

In yet a further example thereof, the first peak temperature is in the range of about 40% to about 80% of the melting point of the working material.

In still a further example thereof, the second peak temperature is in the range of about 70% to about 95% of the melting point of the working material.

In yet still a further example thereof, the fourth peak temperature is in the range of about 50% to about 98% of the melting point of the working material.

In another example thereof, the first peak temperature is at least about 50% of the melting point of the working material.

In yet another example thereof, the second peak temperature is at least about 90% the melting point of the working material.

In still another example thereof, the fourth peak temperature is at least about 90% the melting point of the working material.

In yet still another example thereof, as the irradiation profile is moved along the working path the first portion has a first time duration irradiating the portion of the working material, the second portion has a second time duration irradiating the portion of the working material, the third portion has a third time duration irradiating the portion of the working material, the fourth portion has a fourth time duration irradiating the portion of the working material, each of the first time duration, the second time duration, and the fourth time duration being longer than the third time duration.

In a further example thereof, the third time duration is up to about 50% of the first time duration.

In yet a further example thereof, the third time duration is up to about 50% of the second time duration.

In still a further example thereof, the third time duration is up to about 25% of the fourth time duration.

In yet still a further example thereof, the third time duration is up to about 18% of the fourth time duration.

In another example thereof, the first time duration is up to about 50% of the fourth time duration.

In still another example thereof, the first time duration is up to about 33% of the fourth time duration.

In yet another example thereof, the second time duration is up to about 50% of the fourth time duration.

In still yet another example thereof, the second time duration is up to about 33% of the fourth time duration.

In a further example thereof, at least two of the first peak temperature, the second peak temperature, the third peak temperature, and the fourth peak temperature are independently adjustable.

In yet a further example thereof, at least three of the first peak temperature, the second peak temperature, the third peak temperature, and the fourth peak temperature are independently adjustable.

In still a further example thereof, each of the first peak temperature, the second peak temperature, the third peak temperature, and the fourth peak temperature are independently adjustable.

In still yet a further example thereof, at least two of the first time duration, the second time duration, the third time duration, and the fourth time duration are independently adjustable.

In another example thereof, at least three of the first time duration, the second time duration, the third time duration, and the fourth time duration are independently adjustable.

In yet another example thereof, each of the first time duration, the second time duration, the third time duration, and the fourth time duration are independently adjustable.

In still another example thereof, the illumination system includes a plurality of laser assemblies.

In yet still another example thereof, the illumination system includes a plurality of laser assemblies.

In a further example thereof, the first portion of the of the irradiation profile is provided with a first laser assembly of the plurality of laser assemblies, the second portion of the of the irradiation profile is provided with a second laser assembly of the plurality of laser assemblies, the third portion of the of the irradiation profile is provided with a third laser assembly of the plurality of laser assemblies, and the fourth portion of the of the irradiation profile is provided with a fourth laser assembly of the plurality of laser assemblies.

In still a further example thereof, the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

In yet a further example thereof, the third power profile mode is a Gaussian mode.

In still yet a further example thereof, the second power profile mode and the fourth power profile mode are each a flat top mode.

In yet still another example thereof, the first power profile mode is a doughnut mode.

In another example thereof, the at least one camera is aligned with an axis of the illumination system directed towards the powder bed.

In still another exemplary embodiment of the present disclosure, a method for additive manufacturing is provided. The method comprising: producing the in situ model with an additive manufacturing system; monitoring with the additive manufacturing system the in situ model with the at least one camera as the in situ model is produced by the additive manufacturing system; and analyzing with the additive manufacturing system image data produced by the at least one camera during the production of the in situ model to determine a quality of the in situ model to a CAD model.

In an example thereof, the method further comprises providing a certification for the in situ model produced by the additive manufacturing system when the quality of the in situ model is above a quality threshold.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1a is a schematic view of a conventional SLS application;

FIG. 1b is a schematic representation of a heat application along a working path of the schematic view of FIG. 1a;

FIG. 2a is a schematic view of one exemplary embodiment of this disclosure utilizing a Selective Stepped Laser Fusion (“SSLF”);

FIG. 2b is a schematic exemplary representation of a heat application along a working path of the SSLF embodiment of FIG. 2a;

FIG. 3 is an graphical representation of the exemplary temperature profile as a function of time for a titanium alloy working material undergoing a SSLF manufacturing process;

FIG. 4 is a schematic representation of an exemplary embodiment of an additive manufacturing system; and

FIG. 5 is a schematic representation of an exemplary embodiment of an additive manufacturing method.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

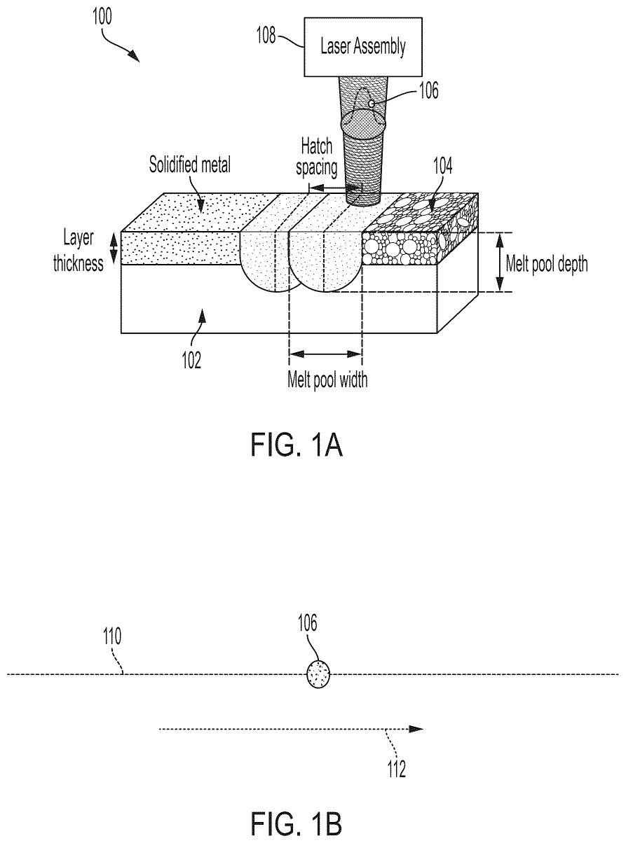

Referring to FIGS. 1a and 1b, a conventional SLS system 100 is illustrated. The conventional SLS system 100 may have a base 102 on which a powder bed 104 of a source or working material may be distributed. The powder bed 104 may be selectively exposed to a single laser beam 106 from a laser assembly 108. The laser assembly may include a gain medium, a pump source, and a resonator along with a controller. The laser beam 106 from the laser assembly 108 may heat the working material on the powder bed 104 to at least the melting point of the working material such that adjacent particles of the working material fuse together at the location the laser beam 106 contacts the powder bed 104. One or more of the base 102 and the laser beam 106 may be moved relative to one another to alter the location the laser beam 106 contacts the powder bed 104 to selectively fuse the working material of the powder bed 104 into the desired form.

In FIG. 1b, a working path 110 is illustrated as an example of a path the laser beam 106 of the conventional SLS system 100 may take along the powder bed 104 to fuse the working material in the desired configuration. More specifically, the single laser beam 106 may travel in a work direction 112 along the powder bed 104 to fuse the working material of the powder bed 104 in a desired configuration determined by a controller of the SLS system 100. The SLS system 100 may create the working path 110 to build a 3D version of a part input electronically into the SLS system (i.e., through a CAD file or the like).

Regardless, in the conventional SLS system 100 of FIGS. 1a and 1b, the single laser beam 106 must apply enough heat to the working material of the powder bed 104 to quickly raise the working material above the melting point (melting temperature) to allow the working material to fuse together as the laser beam 106 progresses along the work direction 112. Because it is desirable to build a 3D part as quickly as possible, among other reasons, the single laser beam 106 of the conventional SLS system 100 often heats the working material very quickly by applying heat that is well greater than the melting point of the working material. As a consequence, the working material on the powder bed 104 of the conventional SLS system 100 is often heated to temperatures well above the melting point of the working material. As mentioned herein, this may provide inconsistent an undesirable outcomes for the part.

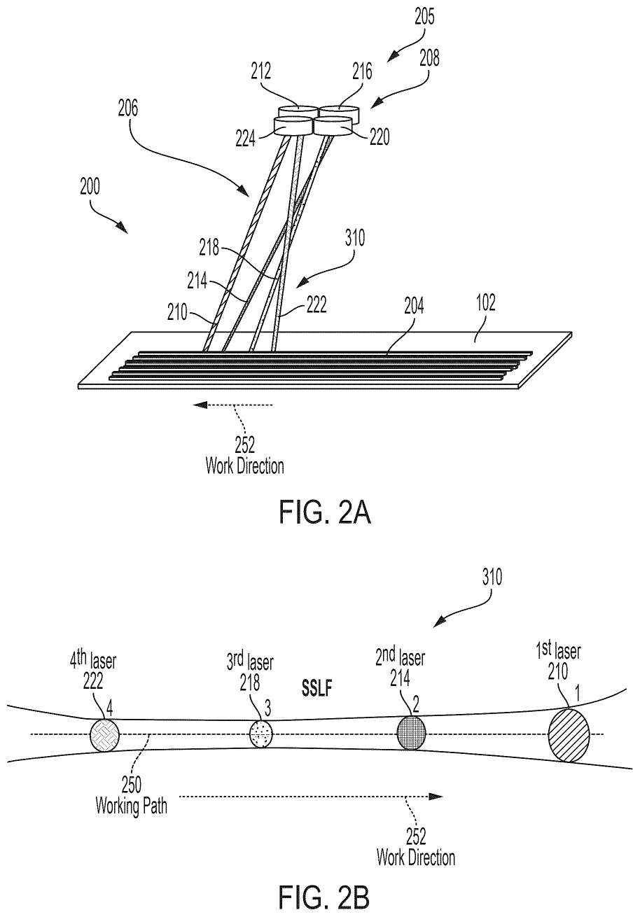

Referring now to FIGS. 2a and 2b, one embodiment of the present disclosure is illustrated providing a Selective Stepped Laser Fusion (“SSLF”) system 200. The SSLF system 200 may have a base 202 on which a powder bed 204 of a source or working material may be distributed. The powder bed 204 may be selectively exposed to an illumination system 205 which provides an irradiation profile 310 to illuminate the working material. In the illustrated embodiment, the illumination system 205 includes a plurality of laser assemblies 208 which produce a plurality of laser beams 206. The plurality of laser beams 206 from the plurality of laser assemblies 208 may heat the working material on the powder bed 204 to at least the melting point of the working material such that adjacent particles of the working material fuse together at the location the plurality of laser beams 206 contact the powder bed 204. One or more of the base 202 and the plurality of laser beams 206 may be moved along the powder bed 204 relative to one another to selectively fuse the working material of the powder bed 204 into the desired form. In embodiments, a given one of the plurality of laser assemblies 208 forms two or more spaced apart portions of irradiation profile 310. As such, in embodiments, a single laser assembly 208 may form the plurality of portions of irradiation profile 310 shown in FIG. 2b.

The plurality of lasers beams 206 produced by the plurality of laser assemblies 208 may include a first laser beam 210 produced by a first laser assembly 212, a second laser beam 214 produced by a second laser assembly 216, a third laser beam 218 produced by a third laser assembly 220, and a fourth laser beam 222 produced by a fourth laser assembly 224. As illustrated in FIG. 2b, the plurality of laser beams 206 may be arranged to follow one another along a working path 250 of the powder bed 204 in a work direction 252 and form an irradiation pattern 310. In this configuration, laser beam 222 may initially heat the working material on the powder bed 204 before the laser beam 210. Similarly, laser beam 214 may follow laser beam 210 and laser beam 218 may follow laser beam 214 in the work direction 252 along the working path 250. In other words, a single point or portion of the working material may be exposed to each of the plurality of laser beams 206 sequentially as the SSLF system 200 moves along the working path 250. In particular in the illustrated embodiment, a portion of the working material would encounter laser beam 210, followed by laser beam 214, followed by laser beam 218, and followed by laser beam 222.

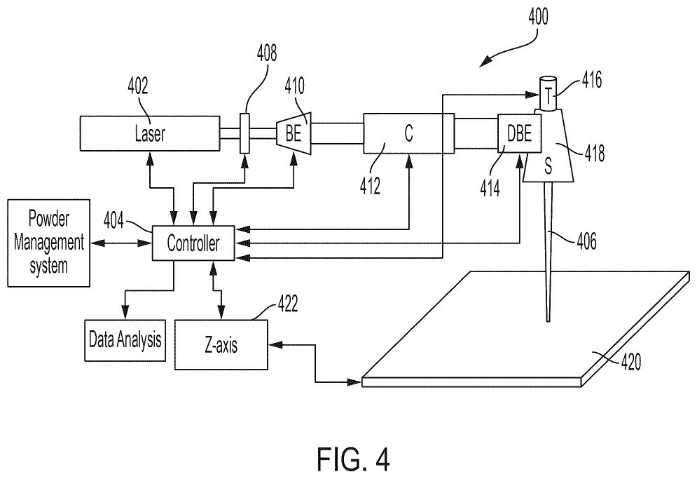

The working path 250 is illustrated as an example of a path the plurality of laser beams 206 may take along the powder bed 204 to fuse the working material in the desired configuration. More specifically, the plurality of laser beams 206 may travel in the work direction 252 along the powder bed 204 to fuse the working material of the powder bed 204 in a desired configuration determined by a controller 404 (see FIG. 4) of the SSLF system 200. The SSLF system 200 may create the working path 250 to build a 3D version of a part input electronically into the SSLF system 200 (i.e., through a CAD file or the like).

Regardless, in the SSLF system 200 of FIGS. 2a and 2b, the plurality of laser beams 206 ultimately apply enough heat to the working material of the powder bed 204 to precisely raise the temperature of a precise portion of the working material above the melting point to allow the working material to fuse together at the precise point as the plurality of laser beams 206 progresses along the work direction 252. The plurality of laser beams of the SSLF system 200 are configured to precisely raise the temperature of the working material to the melting point in a controlled way to produce predictable fusion of the working material on the powder bed 204. More specifically, each of the plurality of laser beams 206 may apply a selected temperature to the working material of the powder bed 204. In one non-exclusive example, laser beam 210 may apply a pre-heat temperature, laser beam 214 may apply a pre-melt temperature, laser beam 218 may apply a melt temperature, and laser beam 222 may apply a post-melt temperature. As a consequence, in use a precise point or portion of the working material on the powder bed 204 of the SSLF system 200 is heated to the melting point of the working material in a sequential manner that is controlled and precise. As such, the 3D parts created using the SSLF system 200 have understood material properties that are predictable, reproducible, and consistent throughout the 3D part. Additionally, in embodiments, controller 404 adjusts the power output of illumination system 205, illustratively plurality of laser assemblies 208, to maintain the temperature of the portion of the working material heated by irradiation profile 310 below a boiling point (temperature) of the working material.

In one aspect of this disclosure, the spacing and power of the plurality of laser beams 206 may be selected based on the type of the working material being used for the powder bed 204 and the material properties thereof. More specifically, the working material of the powder bed 204 can be any known material used in additive manufacturing and the spacing and power of the plurality of laser beams 206 may be selected based on the type of working material. In one example contemplated herein, the working material of the powder bed 204 may be titanium alloy. With this working material, the plurality of laser beams 206 may have the following properties:
laser beam 210 may have a spot size of 400 μm and a laser power of 500 W with a doughnut mode (i.e., pre-heat configuration);
laser beam 214 may have a spot size of 200 μm and a laser power of 300 W with a flat top mode (i.e., pre-melt configuration);
laser beam 218 may have a spot size of 60 μm and a laser power of 200 W with a Gaussian mode (i.e., melt configuration); and
laser beam 222 may have a spot size of 200 μm and a laser power of 300 W with a Flat Top mode (i.e., post-melt configuration).
   A person skilled in the art understands that similar principles can be applied to other working materials and other combinations of laser assemblies with different a different number of laser assemblies, different laser wave lengths, different modes, different spot sizes and different power ranges and this disclosure contemplates applying the teachings discussed herein to any working material known in the art and the specific example provided herein of titanium alloy is only one of many materials contemplated herein for the working material. In embodiments, first laser beam 210 of irradiation profile 310 has a first power profile mode, second laser beam 214 of irradiation profile 310 has a second power profile mode, third laser beam 218 of irradiation profile 310 has a third power profile mode, and fourth laser beam 222 of irradiation profile 310 has a fourth power profile mode, at least one of the first power profile mode, the second power profile mode, and the fourth power profile mode is different than the third power profile mode. In the illustrated embodiment, the third power profile mode is a Gaussian mode, the second power profile mode and the fourth power profile mode are each a flat top mode, and the first power profile mode is a doughnut mode.

Similarly, the spacing or speed of the plurality of laser beams 206 may be altered based on the type of working material. In the titanium alloy example, the spacing and speed of the SSLF system 200 may be such that a first time duration, illustratively a two hundred microsecond timeframe passes, after laser beam 210 heats a precise spot or portion of the working material and before laser beam 214 begins heating the same precise spot or portion of the working material. Similarly, a second time duration, illustratively a two hundred microsecond timeframe passes after laser beam 214 heats the precise spot or portion of the working material and before laser beam 218 begins heating the same precise spot or portion of the working material. A third time duration, illustratively a three hundred microsecond timeframe, passes after laser beam 218 heats the precise spot of the working material and before laser beam 222 begins heating the same precise spot or portion of the working material.

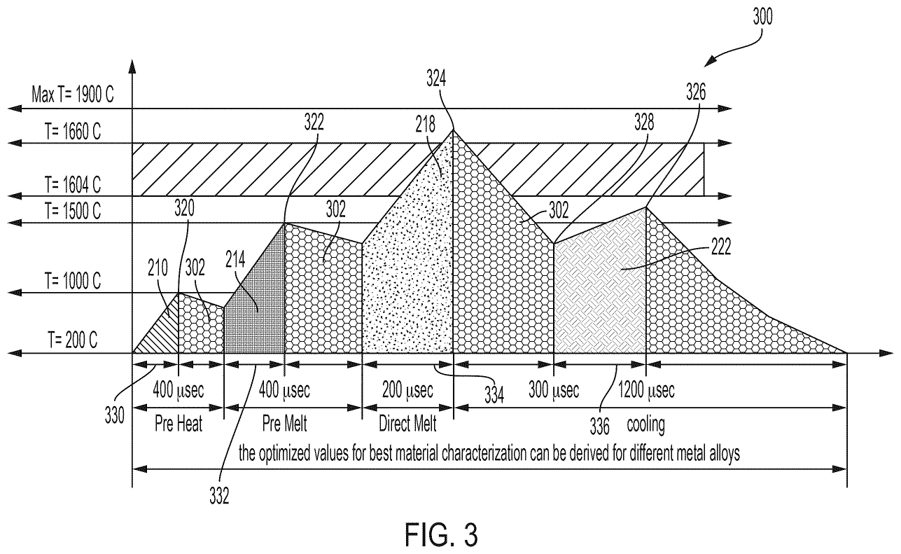

Referring now to FIG. 3, one example of a graphical representation of the temperature as a function of time 300 for a precise location or portion of the working material that is a titanium alloy undergoing the SSLF manufacturing process discussed herein for the SSLF system 200. This example illustrates the sequential heating process discussed herein for the SSLF system 200. As illustrated in the graph 300, only laser beam 218 provides enough heat to advance the working material temperature past the melting point (the melting point of titanium alloy is in the range of 1604° C. to 1660° C. While the temperature is advanced past the melting point it is below the boiling point (the boiling point of titanium alloy is about 2860° C.). The remaining lasers beams 210, 214, 222 are provided to control the heating and cooling gradient of the precise point of the working material. Among other things, this provides a 3D part that has predictable and reproducible material properties because the SSFL system 200 carefully manipulates the working material only to the desired temperatures in the sequential process discussed herein. Additionally, this provides for a spatter free or substantially spatter free processing of the working material.

The timing discussed herein can be achieved as a function of the distance the plurality of laser beams 206 from one another and the speed at which the SSLF system 200 moves the powder bed 204 relative to the plurality of laser assemblies 208. Further, the timing may be selectively altered by a controller of the SSLF system 200 based on the type of working material. The timing may be altered by altering one or more of the speed of the irradiation profile 310 to the powder bed 204, the spot size of one or more of laser beams 206, and the distance between one or more of the laser beams 206. Accordingly, the specific timing of the SSLF system discussed herein for titanium alloy is only one example, and this disclosure contemplates implementing other timing configurations for other types of working materials.

While specific powers, temperatures, and timing for the plurality of lasers are discussed herein for a specific working material, these are meant as only one example of the many different types of materials that a person skilled in the art could apply the teachings of this disclosure too. Accordingly, other specific examples for configurations for the plurality of laser beams 206 may not be specifically included but they are considered a part of this disclosure and a person skilled in the art understands how to develop different control parameters for the SSLF system 200 discussed herein utilizing other working materials.

In use, the SSLF system 200 energizes a precise spot on the working material on the powder bed 204 in a sequence of steps via the plurality of laser beams 206 gradually compared to the SSL system 100. The SSLF system 200 controls the temperatures so the working material reaches liquidous phase while reducing the material exposure to vaporizing temperatures (temperatures above the boiling point). As such, utilizing the SSLF system 200 allows materials to maintain their integrity and characterization for a consistent homogenous working part with less residual stress induced during the manufacturing process. In other words, the SSFL system 200 provides work parts having consistent and predictable material properties ready for certification and more adoptability.

In embodiment, an additive manufacturing system, such as additive manufacturing system 200, may form an in situ model of a part from a working material which is made up of a plurality of powder particles. The additive manufacturing system may include a plurality of laser assemblies, illustratively laser assemblies 208, are provided. The working material is selectively heated with a first laser beam 210 from a first laser assembly 212 of the plurality of laser assemblies 208 to a first peak temperature 320 (see FIG. 3), the first peak temperature being lower than a melting point of the working material. The working material is further selectively heated with a second laser beam 214 from a second laser assembly 216 of the plurality of laser assemblies 208 to a second peak temperature 322 (see FIG. 3) subsequent to the working material being heated to the first peak temperature 320 with the first laser assembly 212 of the plurality of laser assemblies 208, the second peak temperature 322 being higher than the first peak temperature 320 and the second peak temperature being lower than the melting point of the working material. The working material is further selectively heated to a third peak temperature 324 with a third laser beam 218 from a third laser assembly 220 of the plurality of laser assemblies 208 subsequent to the working material being heated to the second peak temperature 322 with the second laser assembly 216 of the plurality of laser assemblies 208, the third peak temperature 324 being higher than the melting point of the working material causing adjacent particles of the working material to fuse to one another. As shown in FIG. 3, the working material may be cooled between the heating by the various laser beams. In embodiments, the first peak temperature 320 is in the range of about 40% to about 80% of the melting point of the working material and the second peak temperature 322 is in the range of about 70% to about 95% of the melting point of the working material. In embodiments, the first peak temperature 320 is at least about 50% of the melting point of the working material the second peak temperature 322 is at least about 90% the melting point of the working material.

In embodiments, the method may further comprise that the working material is selectively heated to a fourth peak temperature 326 with a fourth laser beam 222 from a fourth laser assembly 224 of the plurality of laser assemblies 208 subsequent to the working material being heated to the third peak temperature 324 with the third laser assembly 220 of the plurality of laser assemblies 208, the fourth peak temperature 324 being less than the third peak temperature 322. As shown in FIG. 3, the working material may cool to a fifth temperature 328 less than the fourth peak temperature 326 prior to the working material being selectively heated to the fourth peak temperature 326. As shown in FIG. 3, the working material may be cooled between the heating by the various laser beams. In embodiments, the first peak temperature 320 is at least about 50% of the melting point of the working material the second peak temperature 322 is at least about 90% the melting point of the working material. In embodiments, the fourth peak temperature 326 is in the range of about 50% to about 98% of the melting point of the working material. In embodiments, the fourth peak temperature 326 is at least about 90% the melting point of the working material.

In embodiments, the irradiation profile 310 is moved along the working path 250 such that for a given portion of the working material laser beam 210 heats the portion of the working material for a first time duration 330, laser beam 214 heats the portion of the working material for a second time duration 332, laser beam 218 heats the portion of the working material for a third time duration 334, and laser beam 222 heats the portion of the working material for a fourth time duration 336. Each of first time duration 330, second time duration 332, and fourth time duration 336 may be longer than third time duration 334. The third time duration may be up to about 50% of the first time duration. The third time duration may be up to about 50% of the second time duration. The third time duration may be up to about 25% of the fourth time duration. The third time duration may be up to about 18% of the fourth time duration. The first time duration may be up to about 50% of the fourth time duration. The first time duration may be up to about 33% of the fourth time duration. The second time duration may be up to about 50% of the fourth time duration. The second time duration may be up to about 33% of the fourth time duration.

In embodiments, an additive manufacturing system, such as additive manufacturing system 200, may form an in situ model of a part from a working material which is made up of a plurality of powder particles. The additive manufacturing system 200 may include a plurality of laser assemblies 208. A controller 404 of the additive manufacturing system 200 controls a first subset of the plurality of laser assemblies 208 to heat a portion of the working material in a stepped increase in temperature target points. The stepped increase in temperature target points including a plurality of steps. A first step of the plurality of steps being spaced apart from a second step of the plurality of steps by a beam gap portion 302. The portion of the working material cools during the beam gap portion 302. The controller 404 of additive manufacturing system 200 fuses the portion of the working material with a second subset of the plurality of laser assemblies 208 modifies a post fusion temperature of the portion of the working material with a third subset of the plurality of laser assemblies 208 to provide a controlled cooling temperature decline of the portion of the working material post fusion. In embodiments, at least two laser assemblies of the plurality of laser assemblies 208 are directed towards the portion of working material to provide heat to gradually raise a temperature of the portion of the working material above a melting point of the working material while keeping the temperature of the portion of the working material at about or below a boiling point of the working material.

The first subset of the plurality of laser assemblies may include a first laser assembly 212 and a second laser assembly 216. The first subset and the second subset of the plurality of laser assemblies 208 may be disjoint. The first subset and the third subset of the plurality of laser assemblies 208 may be disjoint. The second subset and the third subset of the plurality of laser assemblies 208 may be disjoint.

In embodiments, an additive manufacturing system, such as additive manufacturing system 200, may form an in situ model of a part from a working material which is made up of a plurality of powder particles. In embodiments, the additive manufacturing system includes an illumination system with one or more laser assemblies to provide an irradiation profile. In one embodiment, a single laser assembly is included. In another embodiment, like additive manufacturing system 200, a plurality of laser assemblies 208 are included. The plurality of laser assemblies 208 may have their output guided through a common delivery system, such as a fiber optic system, to ultimately provide irradiation profile 310 to the working material.

A controller of the additive manufacturing system may produce an irradiation profile, such as irradiation profile 310, with the illumination system, such as illumination system 205. The irradiation profile is directed towards the working material and is moved along a working path, such as working path 250, at the working material to fuse adjacent particles of the working material along the working path together. In embodiments, the irradiation profile includes at least (a) a first portion that heats the working material to a first peak temperature lower than a melting point of the working material, (b) a second portion that heats the working material to a second peak temperature being higher than the first peak temperature and lower than the melting point of the working material, (c) a third portion that heats the working material to a third peak temperature being higher than the melting point of the working material, and (d) a fourth portion that heats the working material to a fourth peak temperature being less than the third peak temperature, wherein as the irradiation profile is moved along the working path a portion of the working material along the working path sequentially encounters the first portion, the second portion, the third portion, and the fourth portion. One example of the temperatures experienced by exposure to such a irradiation profile is shown in FIG. 3.

A first gap, such as beam gap portion 302 shown in FIG. 3, may be provided between the first portion and the second portion, the working material heated by the first portion cools during the first gap. A second gap, such as beam gap portion 302 shown in FIG. 3, may be provided between the second portion and the third portion, the working material heated by the second portion cools during the second gap. A third gap, such as beam gap portion 302 shown in FIG. 3, may be provided between the third portion and the fourth portion, the working material heated by the third portion cools during the third gap. The first peak temperature, such as first peak temperature 320, is in the range of about 40% to about 80% of the melting point of the working material. The second peak temperature, such as second peak temperature 322, is in the range of about 70% to about 95% of the melting point of the working material. The fourth peak temperature, such as fourth peak temperature 326, is in the range of about 50% to about 98% of the melting point of the working material. The first peak temperature may be at least about 50% of the melting point of the working material. The second peak temperature may be at least about 90% the melting point of the working material. The fourth peak temperature may be at least about 90% the melting point of the working material.

As the irradiation profile is moved along the working path, such as 250, the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration. The third time duration may be up to about 50% of the first time duration. The third time duration may be up to about 50% of the second time duration. The third time duration may be up to about 25% of the fourth time duration. The third time duration may be up to about 18% of the fourth time duration. The first time duration may be up to about 50% of the fourth time duration. The first time duration may be up to about 33% of the fourth time duration. The second time duration may be up to about 50% of the fourth time duration. The second time duration may be up to about 33% of the fourth time duration. In some embodiments, at least two of the first peak temperature, the second peak temperature, the third peak temperature, and the fourth peak temperature may be independently adjustable. In some embodiments, at least three of the first peak temperature, the second peak temperature, the third peak temperature, and the fourth peak temperature may be independently adjustable. In some embodiments, each of the first peak temperature, the second peak temperature, the third peak temperature, and the fourth peak temperature may be independently adjustable. In some embodiments, at least two of the first time duration, the second time duration, the third time duration, and the fourth time duration may be independently adjustable. In some embodiments, at least three of the first time duration, the second time duration, the third time duration, and the fourth time duration may be independently adjustable. In some embodiments, each of the first time duration, the second time duration, the third time duration, and the fourth time duration may be independently adjustable.

Referring now to FIG. 4, one embodiment of an optical design for monitoring an additive manufacturing system 400 is illustrated. The system 400 may have a laser 402 selectively powered by a controller 404 to produce a beam 406 to ultimately alter the temperature of a working material on a powder bed 420. The controller 404 may manipulate the positioning of the powder bed 420 via an axis mechanism 422, such as along a vertical direction to permit the addition of additional powder layers as production continues. Further, the controller 404 may manipulate a powder management system 424 to selectively provide the working material to the powder bed 420.

The laser 402 may initially generate a beam directed through a power filtration mechanism 408. The power filtration mechanism 408 may measure the actual power produced by the laser 402 and provide the power value to the controller 404 to ensure the laser 402 output is the desired power. An exemplary power filtration mechanism includes a beam splitter positioned in the path of the laser beam and a sensor positioned to provide an indication of the power of the laser beam based on the portion of the laser beam directed by the beam splitter towards the sensor instead of towards the powder bed. The portion of the laser beam still propagating towards the powder bed may then be directed through a beam expander 410 wherein the size of the laser beam may be manipulated. The laser beam may also be directed through a collimator 412 to further manipulate the laser beam to have the desired properties for the application. The laser beam may be directed through a dynamic beam expander 414 before being directed towards the powder bed 420 through a scanner 418 which directs the laser beam to a specific portion of the working material in the horizontal plane. In embodiments, additive manufacturing system 400 may produce the various irradiation profiles at the working material described herein with one or more laser assemblies.

In one aspect of this disclosure, at least one camera 416 may be positioned to view the beam 406 as it encounters the working material on the powder bed 420. The camera 416 may be an infrared camera or any other type of camera able to view and analyze the beam 406 and the working material. The camera 416 may provide input to the controller 404 that identifies the shape and intensity of the beam 406 as it contacts the working material on the powder bed 420. Further, the camera 416 may be positioned to observe the interaction of the beam 406 with the working material to provide feedback to the controller 404 regarding the quality of the fusion of the working material at the powder bed 420. In other words, the camera 416 provides feedback to the controller 404 that indicates the quality of the beam 406 contacting the working material and quality of the fusion of the working material at the powder bed 420. In the irradiation profiles disclosed herein, the laser beam through a stepped pre-heating of the working material is able to maintain the temperature of the working material below the boiling point for the working material during fusion. Additionally, at least some of the irradiation profiles disclosed herein, post heating of the working material assists in improving the quality of the in situ model by reducing cracking and other undesired qualities. By monitoring the quality of the in situ model during production, controller 404 may alter one or more of the power level, spot size, mode, of any laser beam that forms part of the irradiation profile, the separation between portions of the irradiation profile on the working material, and the speed of the irradiation profile across the working material to improve the quality of the in situ model.

In one aspect of this disclosure, the additive manufacturing system 400 may be an SSLF system 200 that contains more than one laser 402. In this configuration, each laser may have a camera that specifically observes that particular laser and provides feedback to the controller 404 regarding the same. Alternatively, a single camera may observe multiple points of contact between the laser beams and the working material to provide image data to the controller 404 that is analyzed for each laser. Accordingly, the teachings discussed herein regarding utilizing a camera 416 to assess the quality of an additive manufacturing system are considered for other applications and configurations other than those specifically described herein.

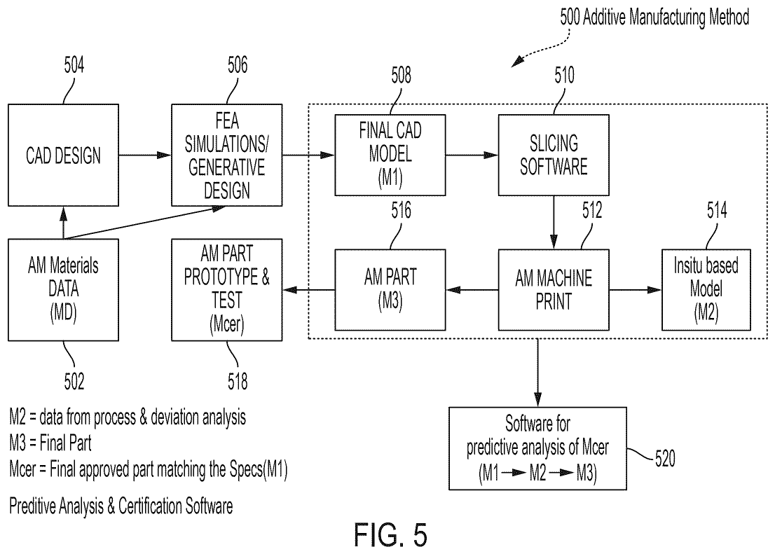

Referring now to FIG. 5, an additive manufacturing method 500 is illustrated. The method may be stored in a memory unit and implement by the controller 404 utilizing the image data provided by the camera 416. The controller 404 may contain one or more processors configured to execute algorithms, programs, and the like stored in the memory unit or otherwise provided to the controller 404. The memory unit may include logic which monitors the in situ model with the at least one camera as the in situ model is produced by the additive manufacturing system and analyzes image data produced by the at least one camera during the production of the in situ model to determine a quality of the in situ model to a CAD model. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. This disclosure contemplates other embodiments in which the controller is not microprocessor-based, but rather is configured to control operation of additive manufacturing system based on one or more sets of hardwired instructions. Further, controller may be contained within a single device or be a plurality of devices networked together or otherwise electrically connected to provide the functionality described herein.

Controller may further receive input through one or more input devices. Exemplary input devices include cameras, sensors, keyboards, buttons, switches, levers, dials, touch displays, soft keys, and a communication module. Controller may further provide output through one or more output devices 182. Exemplary output devices include visual indicators, audio indicators, and a communication module. Exemplary visual indicators include displays, lights, and other visual systems. Exemplary audio indicators include speakers and other suitable audio systems.

Returning to FIG. 5, the method 500 may start by considering the additive manufacturing materials data in box 502. This data may include the type of working material, among other things.

Next, the controller 404 may review a Computer Aided Design (“CAD”) provided in box 504. The CAD may provide the dimensional and material data for the desired prototype part. Next in box 506, the controller 404 may execute a Finite Element Analysis (“FEA”) and/or generative design to evaluate the provided CAD model from box 504. In box 508, the controller 404 may generate a final CAD model (M1) that considers the information provided in boxes 502, 504, 506 and is appropriate for the additive manufacturing system producing the part. In box 510 the final CAD model (M1) is processed by slicing software to be implemented by the additive manufacturing system.

In box 512 the additive manufacturing system produces the part using an additive manufacturing system, such as additive manufacturing system 400. The additive manufacturing system may have at least one camera to evaluate the quality of the laser beam and fusion of the working material, among other things, during the additive manufacturing process. In embodiments, the at least one camera includes a thermal camera. The controller 404 may based on the image data of the thermal camera determine a thermal characteristics of the working material and in particular of the working material along the working trajectory and/or adjacent thereto. Exemplary thermal characteristics include temperature range, peak temperatures, low temperatures, heating rate, cooling rate, and a visual temperature distribution across the irradiation profile of the illumination system at the working material. In embodiments, the at least one camera includes a white light or visual camera. The controller 404 may based on the image data of the white light or visual camera determine a characteristic of the printing process. Exemplary characteristics include determining a width of the working material being fused by the illumination system and whether that width is acceptable or bulging too wide or being too narrow. The controller 404 may be further configured to adjust at least one of the plurality of spaced apart portions of the irradiation profile directed at the working material based on the image data while the illumination system follows the working path to improve a characteristic of the in situ model. An exemplary characteristic is a porosity of the in situ model. Controller 404 may adjust the illumination system to independently adjust the first peak temperature, the second peak temperature, the third peak temperature, and the fourth peak temperature. This may be accomplished in a number of ways, such as by varying laser power, spot size, and time duration that a given laser beam portion is irradiating the portion of the working material. In box 514, the controller 404 may produce a quality rating for the in situ model (M2) generated by the additive manufacturing system in box 512. The quality rating may be generated based on the observations of the camera during the additive manufacturing system printing process of box 512. Further, the actual properties of the in situ model (M2) as observed by the camera during the printing process may be compared to the properties that are assumed in the final CAD model (M1). The controller may determine a quality rating of the in situ model (M2) when compared to the final CAD model (M1) based on the printing process observed by the camera.

The in situ model (M2) may be further processed as an additive manufacturing part (M3) in box 516. Part (M3) may have refined finishes, such as polishing or the like, applied to the in situ model (M2) to prepare the part for prototype testing or use as indicated in box 518.

In one aspect of this disclosure, the controller 404 may continually monitor and analyze the additive manufacturing process for any one part as indicated in box 520. For example, the controller 404 may consider the final CAD model (M1) as processed through CAD and FEA simulations/generative design as outlined in boxes 502, 504, 506. The controller 404 may also compare the in situ model (M2) as produced by the additive manufacturing process, considering the image data provided by the camera during the printing process in box 512. In this configuration, the controller 404 can provide a quality assurance regarding the part produced based on the image data observed during the printing process. Further, in one aspect of this disclosure the data observed and analyzed by the controller 404 for this method 500 may be utilized for predictive analysis and part certification for future parts, among other things. In embodiments, the controller is configured to provide a certification for the in situ model produced by the additive manufacturing system when the quality of the in situ model is above a quality threshold.

While a controller 404 has been discussed herein as implementing the method 500 described, other embodiments contemplated herein may utilize multiple controllers to implement this method 500. Accordingly, this disclosure contemplates utilizing any known method capable of implementing the method discussed herein.

### ADDITIONAL EXAMPLE EMBODIMENTS

Example embodiments of the present disclosure are set out in the following items:

Example 1. A method for additive manufacturing of an in situ model of a part from a working material having a plurality of powder particles is provided. The method comprising: providing a plurality of laser assemblies; selectively heating the working material with a first laser beam from a first laser assembly of the plurality of laser assemblies to a first peak temperature; selectively heating the working material with a second laser beam from a second laser assembly of the plurality of laser assemblies to a second peak temperature subsequent to the working material being heated to the first peak temperature with the first laser assembly of the plurality of laser assemblies; and selectively heating the working material to a third peak temperature with a third laser beam from a third laser assembly of the plurality of laser assemblies subsequent to the working material being heated to the second peak temperature with the second laser assembly of the plurality of laser assemblies. The first peak temperature being lower than a melting point of the working material. The second peak temperature being higher than the first peak temperature and the second peak temperature being lower than the melting point of the working material. The third peak temperature being higher than the melting point of the working material causing adjacent particles of the working material to fuse to one another.

Example 2. The method of Example 1, further comprising the step of selectively heating the working material to a fourth peak temperature with a fourth laser beam from a fourth laser assembly of the plurality of laser assemblies subsequent to the working material being heated to the third temperature with the third laser assembly of the plurality of laser assemblies. The fourth peak temperature being less than the third peak temperature.

Example 3. The method of Example 2, wherein the working material cools to a fifth temperature less than the fourth peak temperature prior to the step of selectively heating the working material to the fourth peak temperature.

Example 4. The method of any one of Examples 1-3, further comprising the step of cooling the working material between the step of selectively heating the working material with the first laser assembly and the step of selectively heating the working material with the second laser assembly.

Example 5. The method of any one of Examples 1-4, further comprising the step of cooling the working material between the step of selectively heating the working material with the second laser assembly and the step of selectively heating the working material with the third laser assembly.

Example 6. The method of any one of Examples 2-5, further comprising the step of cooling the working material between the step of selectively heating the working material with the third laser assembly and the step of selectively heating the working material with the fourth laser assembly.

Example 7. The method of any one of Examples 1-6, wherein the first peak temperature is in the range of about 40% to about 80% of the melting point of the working material.

Example 8. The method of any one of Examples 1-7, wherein the second peak temperature is in the range of about 70% to about 95% of the melting point of the working material.

Example 9. The method of any one of Examples 2-8, wherein the fourth peak temperature is in the range of about 50% to about 98% of the melting point of the working material.

Example 10. The method of any one of Examples 1-9, wherein the first peak temperature is at least about 50% of the melting point of the working material.

Example 11. The method of any one of Examples 1-10, wherein the second peak temperature is at least about 90% the melting point of the working material.

Example 12. The method of any one of Examples 2-11, wherein the fourth peak temperature is at least about 90% the melting point of the working material.

Example 13. The method of any one of Examples 2-12, further comprising the step of moving an irradiation profile produced by the first laser assembly, the second laser assembly, the third laser assembly, and the fourth laser assembly relative to the working material along a working path. The first laser assembly producing a first portion of the irradiation pattern which heats the working material to the first peak temperature. The second laser assembly producing a second portion of the irradiation pattern which heats the working material to the second peak temperature. The third laser assembly producing a third portion of the irradiation pattern which heats the working material to the third peak temperature. The fourth laser assembly producing a fourth portion of the irradiation pattern which heats the working material to the fourth peak temperature.

Example 14. The method of Example 13, wherein as the irradiation profile is moved along the working path the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration.

Example 15. The method of Example 14, wherein the third time duration is up to about 50% of the first time duration.

Example 16. The method of any one of Examples 14 and 15, wherein the third time duration is up to about 50% of the second time duration.

Example 17. The method of any one of Examples 14-16, wherein the third time duration is up to about 25% of the fourth time duration.

Example 18. The method of any one of Examples 14-16, wherein the third time duration is up to about 18% of the fourth time duration.

Example 19. The method of any one of Examples 14-18, wherein the first time duration is up to about 50% of the fourth time duration.

Example 20. The method of any one of Examples 14-19, wherein the first time duration is up to about 33% of the fourth time duration.

Example 21. The method of any one of Examples 14-20, wherein the second time duration is up to about 50% of the fourth time duration.

Example 22. The method of any one of Examples 14-21, wherein the second time duration is up to about 33% of the fourth time duration.

Example 23. The method of any one of Examples 2-22, wherein the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

Example 24. The method of Example 23, wherein the third power profile mode is a Gaussian mode.

Example 25. The method of any one of Examples 23 and 24, wherein the second power profile mode and the fourth power profile mode are each a flat top mode.

Example 26. The method of any one of Examples 23-25, wherein the first power profile mode is a doughnut mode.

Example 27. A method for additive manufacturing of an in situ model of a part from a working material having a plurality of powder particles is provided. The method comprising: providing a plurality of laser assemblies; controlling a first subset of the plurality of laser assemblies to heat a portion of the working material in a stepped increase in temperature target points; fusing the portion of the working material with a second subset of the plurality of laser assemblies; and modifying a post fusion temperature of the portion of the working material with a third subset of the plurality of laser assemblies to provide a controlled cooling temperature decline of the portion of the working material post fusion. The stepped increase in temperature target points including a plurality of steps. A first step of the plurality of steps being spaced apart from a second step of the plurality of steps by a beam gap portion. The portion of the working material cools during the beam gap portion. At least two laser assemblies of the plurality of laser assemblies are directed towards the portion of working material to provide heat to gradually raise a temperature of the portion of the working material above a melting point of the working material while keeping the temperature of the portion of the working material at about or below a boiling point of the working material.

Example 28. The method of Example 27, wherein the first subset of the plurality of laser assemblies includes a first laser assembly and a second laser assembly.

Example 29. The method of any one of Examples 27 and 28, wherein the first subset and the second subset of the plurality of laser assemblies are disjoint.

Example 30. The method of any one of Examples 27-29, wherein the first subset and the third subset of the plurality of laser assemblies are disjoint.

Example 31. The method of any one of Examples 27-30, wherein the second subset and the third subset of the plurality of laser assemblies are disjoint.

Example 32. A method for additive manufacturing of an in situ model of a part from a working material having a plurality of powder particles is provided. The method comprising the steps of: producing an irradiation profile with an illumination system; directing the irradiation profile towards the working material; and moving the irradiation profile along a working path at the working material to fuse adjacent particles of the working material along the working path together. The irradiation profile including (a) a first portion that heats the working material to a first peak temperature lower than a melting point of the working material, (b) a second portion that heats the working material to a second peak temperature being higher than the first peak temperature and lower than the melting point of the working material, (c) a third portion that heats the working material to a third peak temperature being higher than the melting point of the working material, and (d) a fourth portion that heats the working material to a fourth peak temperature being less than the third peak temperature. As the irradiation profile is moved along the working path a portion of the working material along the working path sequentially encounters the first portion, the second portion, the third portion, and the fourth portion.

Example 33. The method of Example 32, wherein a first gap is provided between the first portion and the second portion, the working material heated by the first portion cools during the first gap.

Example 34. The method of any one of Examples 32 and 33, wherein a second gap is provided between the second portion and the third portion, the working material heated by the second portion cools during the second gap.

Example 35. The method of any one of Examples 32-34, wherein a third gap is provided between the third portion and the fourth portion, the working material heated by the third portion cools during the third gap.

Example 36. The method of any one of Examples 32-35, wherein the first peak temperature is in the range of about 40% to about 80% of the melting point of the working material.

Example 37. The method of any one of Examples 32-35, wherein the second peak temperature is in the range of about 70% to about 95% of the melting point of the working material.

Example 38. The method of any one of Examples 32-35, wherein the fourth peak temperature is in the range of about 50% to about 98% of the melting point of the working material.

Example 39. The method of any one of Examples 32-38, wherein the first peak temperature is at least about 50% of the melting point of the working material.

Example 40. The method of any one of Examples 32-39, wherein the second peak temperature is at least about 90% the melting point of the working material.

Example 41. The method of any one of Examples 32-40, wherein the fourth peak temperature is at least about 90% the melting point of the working material.

Example 42. The method of any one of Examples 32-41, wherein as the irradiation profile is moved along the working path the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration.

Example 43. The method of Example 42, wherein the third time duration is up to about 50% of the first time duration.

Example 44. The method of any one of Examples 42 and 43, wherein the third time duration is up to about 50% of the second time duration.

Example 45. The method of any one of Examples 42-44, wherein the third time duration is up to about 25% of the fourth time duration.

Example 46. The method of any one of Examples 42-44, wherein the third time duration is up to about 18% of the fourth time duration.

Example 47. The method of any one of Examples 42-46, wherein the first time duration is up to about 50% of the fourth time duration.

Example 48. The method of any one of Examples 42-47, wherein the first time duration is up to about 33% of the fourth time duration.

Example 49. The method of any one of Examples 42-48, wherein the second time duration is up to about 50% of the fourth time duration.

Example 50. The method of any one of Examples 42-49, wherein the second time duration is up to about 33% of the fourth time duration.

Example 51. The method of any one of Examples 32-50, wherein at least two of the first peak temperature, the second peak temperature, the third peak temperature, and the fourth peak temperature are independently adjustable.

Example 52. The method of any one of Examples 32-50, wherein at least three of the first peak temperature, the second peak temperature, the third peak temperature, and the fourth peak temperature are independently adjustable.

Example 53. The method of any one of Examples 32-50, wherein each of the first peak temperature, the second peak temperature, the third peak temperature, and the fourth peak temperature are independently adjustable.

Example 54. The method of any one of Examples 42-53, wherein at least two of the first time duration, the second time duration, the third time duration, and the fourth time duration are independently adjustable.

Example 55. The method of any one of Examples 42-53, wherein at least three of the first time duration, the second time duration, the third time duration, and the fourth time duration are independently adjustable.

Example 56. The method of any one of Examples 42-53, wherein each of the first time duration, the second time duration, the third time duration, and the fourth time duration are independently adjustable.

Example 57. The method of any one of Examples 32-56, further comprising the step of providing the irradiation profile with a plurality of laser assemblies.

Example 58. The method of Example 57, wherein the first portion of the of the irradiation profile is provided with a first laser assembly of the plurality of laser assemblies, the second portion of the of the irradiation profile is provided with a second laser assembly of the plurality of laser assemblies, the third portion of the of the irradiation profile is provided with a third laser assembly of the plurality of laser assemblies, and the fourth portion of the of the irradiation profile is provided with a fourth laser assembly of the plurality of laser assemblies.

Example 59. The method of any one of Examples 32-58, wherein the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

Example 60. The method of Example 59, wherein the third power profile mode is a Gaussian mode.

Example 61. The method of any one of Examples 59 and 60, wherein the second power profile mode and the fourth power profile mode are each a flat top mode.

Example 62. The method of any one of Examples 59-61, wherein the first power profile mode is a doughnut mode.

Example 63. An additive manufacturing system for forming an in situ model of a part from a working material having a plurality of powder particles is provided. The additive manufacturing system comprising: a powder bed adapted to support the working material; an illumination system configured to illuminate the working material with an irradiation profile; and a controller configured to cause the illumination system to follow a working path while illuminating the working material with the irradiation profile. The irradiation profile including (a) a first portion that heats the working material to a first peak temperature lower than a melting point of the working material, (b) a second portion that heats the working material to a second peak temperature being higher than the first peak temperature and lower than the melting point of the working material, (c) a third portion that heats the working material to a third peak temperature being higher than the melting point of the working material, and (d) a fourth portion that heats the working material to a fourth peak temperature being less than the third peak temperature, wherein as the irradiation profile is moved along the working path a portion of the working material along the working path sequentially encounters the first portion, the second portion, the third portion, and the fourth portion.

Example 64. The additive manufacturing system of Example 63, wherein the controller is further configured to execute the method of any one of Examples 32-62.

Example 65. An additive manufacturing system for forming an in situ model of a part from a working material having a plurality of powder particles is provided. The additive manufacturing system comprising: a powder bed supporting the working material; an illumination system configured to illuminate the working material with an irradiation profile; and a controller configured to cause the illumination system to follow a working path while illuminating the working material with the irradiation profile. The irradiation profile including a plurality of spaced apart portions which each selectively heat the working material to a plurality of spaced apart peak temperatures. The plurality of spaced apart peak temperatures all being lower than a boiling point of the working material. The plurality of spaced apart portions including a first subset pre-heating a portion of the working material while keeping a temperature of the portion of the working material below a melting point of the portion of the working material, a second subset fusing the portion of the working material while keeping the temperature of the portion of the working material below the boiling point of the working material; and a third subset post-heating the portion of the working material while keeping the temperature of the portion of the working material below the melting point. The additive manufacturing system further comprising at least one camera oriented to observe the portion of the working material. The controller is configured to analyze image data provided by the camera while the illumination system follows the working path.

Example 66. The additive manufacturing system of Example 65, wherein the controller is further configured to adjust at least one of the plurality of spaced apart portion of the irradiation profile based on the image data while the illumination system follows the working path to improve a characteristic of the in situ model.

Example 67. The additive manufacturing system of Example 66, wherein the characteristic of the in situ model is a porosity of the in situ model.

Example 68. The additive manufacturing system of any one of Examples 65-67, wherein the controller is further configured to provide a quality assessment of the in situ model produced by the printing process based on the image data.

Example 69. The additive manufacturing system of any one of Examples 65-68, wherein the spaced apart portions of the irradiation profile include (a) a first portion that heats the working material to a first peak temperature of the plurality of spaced apart peak temperatures lower than a melting point of the working material, (b) a second portion that heats the working material to a second peak temperature of the plurality of spaced apart peak temperatures being higher than the first peak temperature and lower than the melting point of the working material, (c) a third portion that heats the working material to a third peak temperature of the plurality of spaced apart peak temperatures being higher than the melting point of the working material and lower than the boiling point of the working material, and (d) a fourth portion that heats the working material to a fourth peak temperature of the plurality of spaced apart peak temperatures being less than the third peak temperature, wherein the first portion and the second portion are part of the first subset, the third portion is part of the second subset, and the fourth portion is part of the third subset, as the irradiation profile is moved along the working path the portion of the working material sequentially encounters the first portion, the second portion, the third portion, and the fourth portion.

Example 70. The additive manufacturing system of Example 69, wherein a first gap is provided between the first portion and the second portion, the working material heated by the first portion cools during the first gap; a second gap is provided between the second portion and the third portion, the working material heated by the second portion cools during the second gap; and a third gap is provided between the third portion and the fourth portion, the working material heated by the third portion cools during the third gap.

Example 71. The additive manufacturing system of any one of Examples 69 and 70, wherein the first peak temperature is in the range of about 40% to about 80% of the melting point of the working material.

Example 72. The additive manufacturing system of any one of Examples 69-71, wherein the second peak temperature is in the range of about 70% to about 95% of the melting point of the working material.

Example 73. The additive manufacturing system of any one of Examples 69-72, wherein the fourth peak temperature is in the range of about 50% to about 98% of the melting point of the working material.

Example 74. The additive manufacturing system of any one of Examples 69-73, wherein the first peak temperature is at least about 50% of the melting point of the working material.

Example 75. The additive manufacturing system of any one of Examples 69-74, wherein the second peak temperature is at least about 90% the melting point of the working material.

Example 76. The additive manufacturing system of any one of Examples 69-75, wherein the fourth peak temperature is at least about 90% the melting point of the working material.

Example 77. The additive manufacturing system of any one of Examples 69-76, wherein as the irradiation profile is moved along the working path the first portion has a first time duration irradiating the portion of the working material, the second portion has a second time duration irradiating the portion of the working material, the third portion has a third time duration irradiating the portion of the working material, the fourth portion has a fourth time duration irradiating the portion of the working material, each of the first time duration, the second time duration, and the fourth time duration being longer than the third time duration.

Example 78. The additive manufacturing system of Example 77, wherein the third time duration is up to about 50% of the first time duration.

Example 79. The additive manufacturing system of any one of Examples 77 and 78, wherein the third time duration is up to about 50% of the second time duration.

Example 80. The additive manufacturing system of any one of Examples 77-79, wherein the third time duration is up to about 25% of the fourth time duration.

Example 81. The additive manufacturing system of any one of Examples 77-80, wherein the third time duration is up to about 18% of the fourth time duration.

Example 82. The additive manufacturing system of any one of Examples 77-81, wherein the first time duration is up to about 50% of the fourth time duration.

Example 83. The additive manufacturing system of any one of Examples 77-82, wherein the first time duration is up to about 33% of the fourth time duration.

Example 84. The additive manufacturing system of any one of Examples 77-83, wherein the second time duration is up to about 50% of the fourth time duration.

Example 85. The additive manufacturing system of any one of Examples 77-84, wherein the second time duration is up to about 33% of the fourth time duration.

Example 86. The additive manufacturing system of any one of Examples 69-85, wherein at least two of the first peak temperature, the second peak temperature, the third peak temperature, and the fourth peak temperature are independently adjustable.

Example 87. The additive manufacturing system of any one of Examples 69-85, wherein at least three of the first peak temperature, the second peak temperature, the third peak temperature, and the fourth peak temperature are independently adjustable.

Example 88. The additive manufacturing system of any one of Examples 69-85, wherein each of the first peak temperature, the second peak temperature, the third peak temperature, and the fourth peak temperature are independently adjustable.

Example 89. The additive manufacturing system of any one of Examples 77-88, wherein at least two of the first time duration, the second time duration, the third time duration, and the fourth time duration are independently adjustable.

Example 90. The additive manufacturing system of any one of Examples 77-88, wherein at least three of the first time duration, the second time duration, the third time duration, and the fourth time duration are independently adjustable.

Example 91. The additive manufacturing system of any one of Examples 77-88, wherein each of the first time duration, the second time duration, the third time duration, and the fourth time duration are independently adjustable.

Example 92. The additive manufacturing system of any one of Examples 65-91, wherein the illumination system includes a plurality of laser assemblies.

Example 93. The additive manufacturing system of any one of Examples 69-91, wherein the illumination system includes a plurality of laser assemblies.

Example 94. The additive manufacturing system of Example 93, wherein the first portion of the of the irradiation profile is provided with a first laser assembly of the plurality of laser assemblies, the second portion of the of the irradiation profile is provided with a second laser assembly of the plurality of laser assemblies, the third portion of the of the irradiation profile is provided with a third laser assembly of the plurality of laser assemblies, and the fourth portion of the of the irradiation profile is provided with a fourth laser assembly of the plurality of laser assemblies.

Example 95. The additive manufacturing system of any one of Examples 69-94, wherein the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.

Example 96. The additive manufacturing system of Example 95, wherein the third power profile mode is a Gaussian mode.

Example 97. The additive manufacturing system of any one of Examples 95 and 96, wherein the second power profile mode and the fourth power profile mode are each a flat top mode.

Example 98. The additive manufacturing system of any one of Examples 95-97, wherein the first power profile mode is a doughnut mode.

Example 99. The additive manufacturing system of any one of Examples 65-98, wherein the at least one camera is aligned with an axis of the illumination system directed towards the powder bed.

Example 100. A method for additive manufacturing is provided. The method comprising: producing the in situ model with the additive manufacturing system any one of Examples 65-99; monitoring with the additive manufacturing system the in situ model with the at least one camera as the in situ model is produced by the additive manufacturing system; and analyzing with the additive manufacturing system image data produced by the at least one camera during the production of the in situ model to determine a quality of the in situ model to a CAD model.

Example 101. The method of Example 100, further comprising providing a certification for the in situ model produced by the additive manufacturing system when the quality of the in situ model is above a quality threshold.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1-19. (canceled)

20. A method for additive manufacturing of an in situ model of a part from a working material having a plurality of powder particles, the method comprising the steps of:
producing an irradiation profile with an illumination system;
directing the irradiation profile towards the working material; and
moving the irradiation profile along a working path at the working material to fuse adjacent particles of the working material along the working path together, the irradiation profile including
(a) a first portion that heats the working material to a first peak temperature lower than a melting point of the working material,
(b) a second portion that heats the working material to a second peak temperature being higher than the first peak temperature and lower than the melting point of the working material,
(c) a third portion that heats the working material to a third peak temperature being higher than the melting point of the working material, and
(d) a fourth portion that heats the working material to a fourth peak temperature being less than the third peak temperature, wherein as the irradiation profile is moved along the working path a portion of the working material along the working path sequentially encounters the first portion, the second portion, the third portion, and the fourth portion.

21. The method of claim 20, wherein a first gap is provided between the first portion and the second portion, the working material heated by the first portion cools during the first gap, a second gap is provided between the second portion and the third portion, the working material heated by the second portion cools during the second gap, and a third gap is provided between the third portion and the fourth portion, the working material heated by the third portion cools during the third gap.

22. The method of claim 21, wherein the first peak temperature is in the range of about 40% to about 80% of the melting point of the working material, the second peak temperature is in the range of about 70% to about 95% of the melting point of the working material, and the fourth peak temperature is in the range of about 50% to about 98% of the melting point of the working material.

23. The method of claim 21, wherein the first peak temperature is at least about 50% of the melting point of the working material, the second peak temperature is at least about 90% the melting point of the working material, and the fourth peak temperature is at least about 90% the melting point of the working material.

24. The method of claim 23, wherein as the irradiation profile is moved along the working path the first portion has a first time duration irradiating a first portion of the working material, the second portion has a second time duration irradiating the first portion of the working material, the third portion has a third time duration irradiating the first portion of the working material, the fourth portion has a fourth time duration irradiating the first portion of the working material, each of the first time duration, the second time duration, and the fourth time duration being longer than the third time duration.

25. The method of claim 24, wherein the third time duration is up to about 50% of the first time duration, the third time duration is up to about 50% of the second time duration, and the third time duration is up to about 25% of the fourth time duration.

26. The method of claim 20, wherein at least two of the first peak temperature, the second peak temperature, the third peak temperature, and the fourth peak temperature are independently adjustable.

27. The method of claim 24, wherein at least two of the first time duration, the second time duration, the third time duration, and the fourth time duration are independently adjustable.

28. The method of claim 20, further comprising the step of providing the irradiation profile with a plurality of laser assemblies.

29. The method of claim 28, wherein the first portion of the of the irradiation profile is provided with a first laser assembly of the plurality of laser assemblies, the second portion of the of the irradiation profile is provided with a second laser assembly of the plurality of laser assemblies, the third portion of the of the irradiation profile is provided with a third laser assembly of the plurality of laser assemblies, and the fourth portion of the of the irradiation profile is provided with a fourth laser assembly of the plurality of laser assemblies.

30. The method of claim 20, wherein the first portion of the irradiation profile has a first power profile mode, the second portion of the irradiation profile has a second power profile mode, the third portion of the irradiation profile has a third power profile mode, and the fourth portion of the irradiation profile has a fourth power profile mode, at least one of the first power profile mode, the second power profile mode, and the fourth power profile mode is different than the third power profile mode.
